(19) United States
(12) Patent Application Publication
(10) Pub. No.: US 2003/0006540 A1
(43) Pub. Date: Jan. 9, 2003

(54) Self-aligning mechanism for pneumatic vibration isolators

(76) Inventors: Worthington B. Houghton JR., Newport Beach, CA (US); Herman B. Keil, Cypress, CA (US)

Correspondence Address: Ben J. Yorks, IRELL & MANELLA, LLP, Ste 400, 840 Newport Center Drive, Newport Beach, CA, 92660, US

(21) Appl. No.: 09/901,922

(22) Filed: Jul. 9, 2001

(51) Int. Cl. F16F 5/00

(52) U.S. Cl. 267/140.11; 188/266

(57) ABSTRACT

A vibration isolator with non-circular seating features that allow a payload to be attached to a support plate without twisting cables of the isolator. The cables couple the support plate to a piston that can move within an air charged housing. The support plate may have a non-circular shoulder that can sit within a non-circular seat of the housing when the isolator is deflated. The non-circular shapes prevent rotation of the support plate and twisting of the cables when the payload is attached to the deflated isolator. The vibration isolator may also have anti-rotation features to prevent twisting of the cables when the isolator is charged and the support plate is in a fully extended position.

### BACKGROUND OF THE INVENTION

1. Field of the Invention

The present invention relates to pneumatic vibration isolators.

2. Background Information

Vibration isolators are used to isolate and damp vibration and shock loads, which might otherwise be applied to a working surface from the floor or other surface. Vibration isolators also are used to damp shock or vibration disturbances, which may be on or applied to an isolated payload. For example, vibration isolators typically support the table of semiconductor fabrication equipment to both isolate and damp shock and vibration from the floor that are caused by the docking of a wafer pallet.

Some vibration isolators contain a piston that moves within an air filled cylinder. For example, U.S. Pat. No. 3,784,146 issued to Matthews and U.S. Pat. No. 5,071,108 issued to Houghton disclose vibration isolators with a pneumatic piston that is coupled to a support plate by a plurality of cables. The support plate is typically attached to a payload such as a table, test or manufacturing equipment. The support plate may have a shaft that extends down into a damping fluid. Horizontal movement of the payload and attached support plate may be damped by movement of the shaft within the damping fluid. The cables allow the support shaft to move relative to the piston.

The air within a pneumatic isolator is typically released before a payload is attached to the support plate of the isolator. The '108 patent provides a centering scheme to insure that the isolators are centered when the payload is attached to the support plate. Unfortunately, the support plate can still rotate during the installment process. Rotation of the support plate may twist the cables within the isolator. The twisted cables may reduce the efficiency of the isolator.

### BRIEF SUMMARY OF THE INVENTION

One embodiment of the present invention includes a vibration isolator with a self-aligning support plate. The isolator includes a housing that has an outer non-circular seat and a support plate which has a non-circular shoulder. The support plate is coupled to a pendulum assembly.

### BRIEF DESCRIPTION OF THE DRAWINGS

FIG. 1 is a cross-sectional view of an embodiment of a vibration isolator of the present invention;

FIG. 2 is a top view showing a non-circular seat of an isolator housing;

FIG. 3 is a bottom view showing a non-circular shoulder of an isolator support plate;

FIG. 4 is a bottom inner view of the isolator housing showing an inner alignment seat;

FIG. 5 is a top view of an isolator piston showing an alignment surface of the piston.

### DETAILED DESCRIPTION OF THE PREFERRED EMBODIMENT

The applicants disclose a vibration isolator with non-circular seating features that allow a payload to be attached to a support plate without twisting cables of the isolator. The cables couple the support plate to a piston that can move within an air charged housing. The support plate may have a non-circular shoulder that can sit within a non-circular seat of the housing when the isolator is deflated. The non-circular shapes prevent rotation of the support plate and twisting of the cables when the payload is attached to the deflated isolator. The vibration isolator may also have anti-rotation features to prevent twisting of the cables when the isolator is charged and the support plate is in a fully extended position.

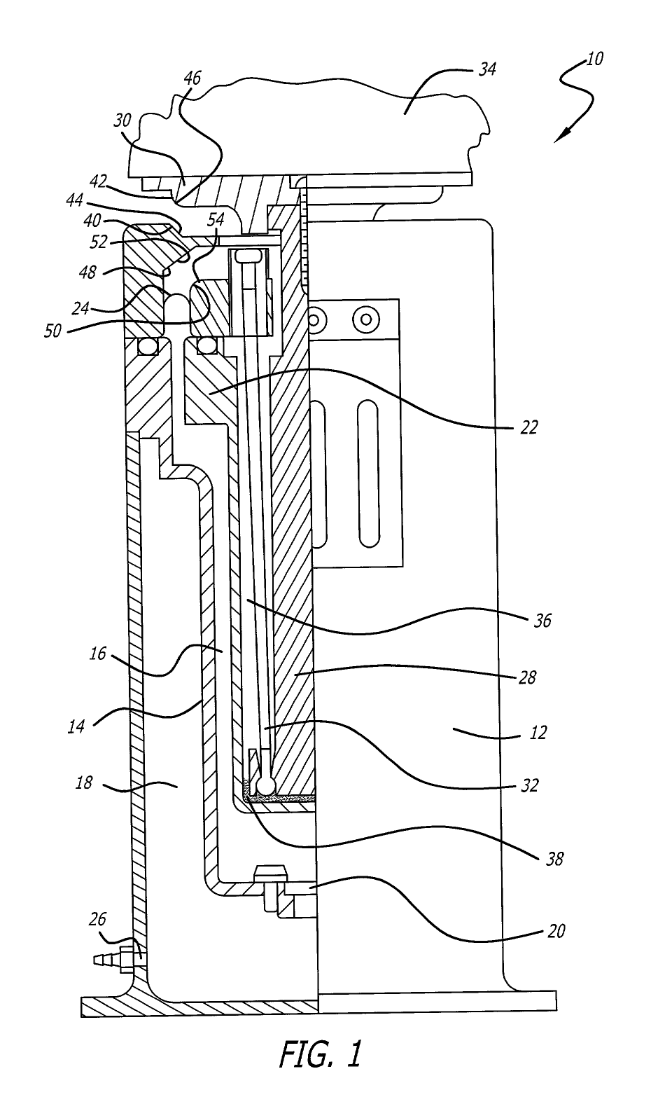

Referring to the drawings more particularly by reference numbers, FIG. 1 shows an embodiment of a vibration isolator 10 of the present invention. The isolator 10 may include a housing 12 that contains an inner cylinder 14. The inner cylinder 14 includes a first inner 20 chamber 16. The cylinder 14 is located within a second inner chamber 18 of the housing 12. A damping element 20, such as an orifice or sintered block, provides fluid communication between the first inner chamber 16 and the second chamber 18.

Located within the first inner chamber 16 is a piston 22 that is coupled to the housing 12 by a diaphragm 24. The diaphragm 24 seals the inner chamber 16 while allowing the piston 22 to move relative to the housing 12. The second chamber 18 may be coupled to an external source (not shown) of pressurized fluid through a leveling port 26. By way of example, the external source may provide pressurized air to the second 18 and first 16 inner chambers.

The piston 22 may be coupled to the support post 28 of a support plate 30 by a plurality of cables 32. The support plate 30 may be attached to a payload 34. By way of example, the payload 34 may be an optical bench or the base of an x-y table. The piston 22 may include an inner cavity 36 that contains a damping fluid 38. Horizontal shock and/or vibrational movement of the payload 34 and support plate 30 may be damped by movement of the support 20 post 28 within the damping fluid 38. The cables 32 allow the support shaft 28 to move within the inner cavity 36 of the piston 22.

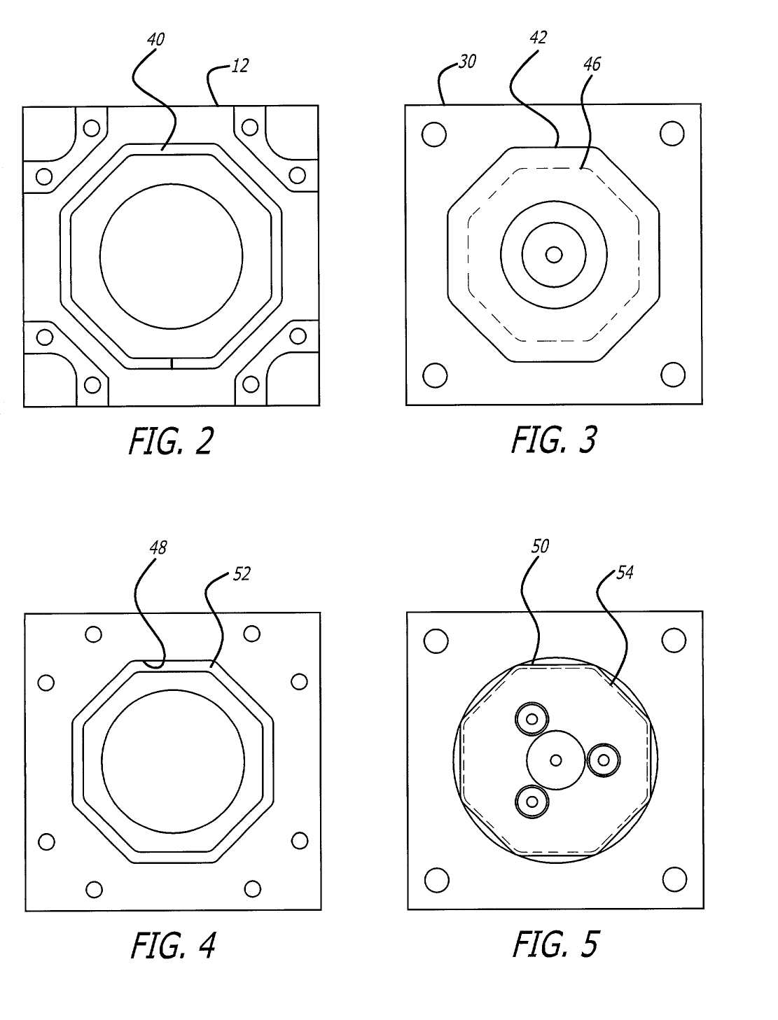

As shown in FIG. 2 the housing 12 may have a noncircular seat 40. As shown in FIG. 3, the support plate 30 may have a non-circular shoulder 42. The shapes of the seat 40 and shoulder 42 should be such to prevent rotation of the support plate 30 relative to the housing 12 when fluid is deflated from the isolator 10. Although octagonal shapes are shown, it is to be understood that other non-circular shapes may be employed in the present invention, including configurations which align in only one orientation.

Referring to FIG. 1, the housing seat 40 may have a tapered surface 44 to lead the shoulder 42 into proper alignment. The shoulder 42 may also have a rounded corner 46 to assist with the seating of the support plate 30.

In operation, the fluid is deflated from the isolator 10 wherein the support plate 30 moves down into the housing seat 40. The payload 34 can then be attached to the support plate 30. The non-circular shoulder 42 and housing seat 40 prevent the support plate 30 from rotating and twisting the cables 32 when the payload 34 is assembled to the isolator 10.

The housing 12 may have a non-circular seat 48 and the piston 22 may have a non-circular outer surface 50 as shown in FIGS. 4 and 5, respectively, that align the support plate 30 when the isolator 10 is fully inflated. The non-circular seat 48 and non-circular outer piston surface 50 may prevent rotation of the support plate 30 in the fully extended position. Such a feature would allow the payload 34 to be attached to the plate 30 without twisting the cables 32 even when the isolator 10 is fully charged. The non-circular seat 48 may include a tapered surface 52 to lead the piston 22 to a centered position. Likewise, the piston 22 may have rounded corners 54 to assist in alignment with the housing 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A vibration isolator, comprising:
a housing that has an outer non-circular seat;
a support plate that has a non-circular shoulder; and,
a pendulum assembly coupled to said support plate.

2. The vibration isolator of claim 1, wherein said outer non-circular seat has a tapered surface.

3. The vibration isolator of claim 1, wherein said pendulum assembly includes a cable that is coupled to a piston and said support plate, said piston being coupled to said housing.

4. The vibration isolator of claim 3, wherein said housing has an inner non-circular seat and said piston has a non-circular outer top surface.

5. The vibration isolator of claim 3, wherein said housing includes an inner cylinder which defines a first inner chamber and is located within a second inner chamber, said piston being located within said first inner chamber.

6. The vibration isolator of claim 5, wherein said inner cylinder includes a damping element.

7. The vibration isolator of claim 3, wherein said piston has an inner cavity that contains a damping fluid.

8. A vibration isolator, comprising:
a housing that has an inner non-circular seat;
a support plate;
a piston that has a non-circular outer surface; and,
a cable coupled to said piston and said support plate.

9. The vibration isolator of claim 8, wherein said inner non-circular seat includes a tapered surface.

10. The vibration isolator of claim 8, wherein said housing has an outer non-circular seat and said support plate has a non-circular shoulder.

11. The vibration isolator of claim 8, wherein said housing includes an inner cylinder which defines a first inner chamber and is located within a second inner chamber, said piston being located within said first inner chamber.

12. The vibration isolator of claim 11, wherein said inner cylinder includes a damping element.

13. The vibration isolator of claim 8, wherein said piston has an inner cavity that contains a damping fluid.

14. A vibration isolator, comprising:
a housing that has outer alignment means;
a support plate that has means for aligning with said housing; and,
a pendulum assembly coupled to said support plate.

15. The vibration isolator of claim 14, wherein said pendulum assembly includes a cable that is coupled to a piston and said support plate, said piston being coupled to said housing.

16. The vibration isolator of claim 15, wherein said housing has inner alignment means and said piston has means for aligning with said housing.

17. The vibration isolator of claim 15, wherein said housing includes an inner cylinder which defines a first inner chamber and is located within a second inner chamber, said piston being located within said first inner chamber.

18. The vibration isolator of claim 17, wherein said inner cylinder includes a damping element.

19. The vibration isolator of claim 15, wherein said piston has an inner cavity that contains a damping fluid.

20. A vibration isolator, comprising:
a housing that has inner alignment means;
a support plate;
a piston that has alignment means for aligning with said housing; and,
a cable coupled to said piston and said support plate.

21. The vibration isolator of claim 20, wherein said housing has outer alignment means and said support plate has means for aligning with said housing.

22. The vibration isolator of claim 20, wherein said housing includes an inner cylinder which defines a first inner chamber and is located within a second inner chamber, said piston being located within said first inner chamber.

23. The vibration isolator of claim 22, wherein said inner cylinder includes a damping element.

24. The vibration isolator of claim 20, wherein said piston has an inner cavity that contains a damping fluid.

25. A method for aligning a support plate of a pneumatic vibration isolator, comprising:
releasing a fluid from a housing of a vibration isolator such that a support plate becomes seated within a non-circular seat of the housing.

26. The method of claim 25, further comprising attaching a payload to the support plate.

27. A method for aligning a support plate of a pneumatic vibration isolator, comprising:
charging a housing with a fluid so that a piston is seated within a non-circular seat of a housing.

28. The method of claim 27, further comprising attaching a payload to the support plate.
